(19) United States
(12) Patent Application Publication
(10) Pub. No.: US 2020/0118188 A1
(43) Pub. Date: Apr. 16, 2020

(54) YARN CRAFTING SYSTEM

(71) Applicant: Steven Paul Springsteen, Burlington, WI (US)

(72) Inventor: Steven Paul Springsteen, Burlington, WI (US)

(21) Appl. No.: 16/598,316

(22) Filed: Oct. 10, 2019

Related U.S. Application Data
(60) Provisional application No. 62/743,646, filed on Oct. 10, 2018.

(51) Int. Cl. G06Q 30/06; G05B 19/4097

(52) U.S. Cl. CPC G06Q 30/0621; G05B 2219/45193; G05B 19/4097

(57) ABSTRACT

A yarn crafting system coupled to a foot pedal control device for tracking a series of stitching steps, representing a resulting pattern, and producing a list of materials associated with navigating through the resulting pattern is provided. The foot pedal device enables a user to retrievably store associated stitch data—series and sequence of stitch locations and associated stitch rounds and rows incorporated in a simultaneously created or improvised yarn craft pattern during the crafting process. Each material from the resulting list of material may be associated with an accompanying round/row/stitch location and/or stich step employed in the resulting improvised pattern, enabling others to download improvised patterns and associated lists of materials for their subsequent use.

### CROSS-REFERENCE TO RELATED APPLICATION

This application claims the benefit of priority of U.S. provisional application No. 62/743,646, filed 10 Oct. 2018, the contents of which are herein incorporated by reference.

### BACKGROUND OF THE INVENTION

The present invention relates to yarn crafts and, more particularly, a yarn crafting system embodying a foot pedal device electronically coupled to a database and display for retrievably storing and representing the series of steps in yarn crafts patterns during the crafting process.

Yarn crafters rely on several sources (places and products) to purchase patterns, to purchase items on a related material list, to manually keep track of their location/round/row and/or to stitch placement within said pattern, and to sell their patterns.

Currently, the crafting process employs manual devices; for instance, round/row/stitch location is kept track of manually through different devices/counters/pencil and paper. Such counters must be turned by hand, clicked by hand or tallied on paper by hand. Giving that stitching is inherently hands-on, so to speak, such handheld solutions can be burdensome and create room for errors from the added manual task.

Furthermore, the current devices do not mark or place references to the steps and the corresponding round/row/stitch locations. As a result, when a user of these devices is interrupted and no reference is kept for the step and the corresponding round/row/stitch location at the moment of interruption, the user's location within the pattern is lost.

As can be seen, there is a need for a yarn crafting system embodying a foot pedal device electronically coupled to a database and display for retrievably storing and representing the series of steps employed during the yarn crafting process, leaving the user handsfree during the stitching.

Through the use of a swipe motion and/or foot pedal navigation the present invention electronically stores the steps and the corresponding round/row/stitch locations as an immediately accessible marker for future reference, allowing the user to continue from the exact location they left off at.

Furthermore, the present invention allows designers to purchase one or more patterns, purchase the material required for said one or more patterns, and build the item from the pattern through a series of steps navigated using a swipe motion or foot pedal that automatically stores the location/round/row and or stitch placement of their location within the pattern, and/or sell their patterns. Likewise, users designing their own novel and/or improvised patterns, may use the swipe motion or foot pedal navigation system embodied in the present invention to retrievably store their heretofore unknown pattern as they stitch it.

### SUMMARY OF THE INVENTION

In one aspect of the present invention, a yarn crafting system includes the following: a computer; and a foot pedal control device electrically coupled to the computer, wherein a series of stitches in a yarn crafting process involving a plurality of crafting articles is tracked and retrievable stored through manipulation of the foot pedal control device, wherein the computer is configured to retrievably store a list of materials comprising the plurality of crafting articles, wherein the computer is configured to retrievably store a stich round, stitch row, and a stitch location associated with the series of stitches, wherein the computer is configured to retrievably associate each crafting article of the plurality of crafting articles with at least one of the stich round, stitch row, and a stitch location, wherein the series of stitches may be defined and represented as a crafting pattern, wherein the plurality of crafting articles comprises the type and color of yarn or equivalent filament of crocheting, knitting, needlepoint and weaving or other crafting processes.

In another aspect of the present invention, the above-mentioned yarn crafting system further includes the following: a design center for exporting the crafting pattern and associated list of materials for subsequent download by remote users; and a voice control functionality coupled to the computer, wherein the voice control functionality is configured to be activated by a set of predefined word commands for navigating the crafting pattern.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a flow chart of an exemplary embodiment of the present invention;

FIG. 3 is a flow chart of an exemplary embodiment of the present invention;

FIG. 4 is a flow chart of an exemplary embodiment of the present invention; and

FIG. 5 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a yarn crafting system coupled to a foot pedal control device. The foot pedal device enables a user to retrievably store the series and sequence of stitch locations and associated stitch rounds and rows (e.g., “stitch data”) incorporated in a simultaneously created or improvised yarn craft pattern during the crafting process. The resulting stitch data provides a road map for subsequent users to navigate through the improvised pattern when they recreate it. The yarn crafting system tracks and stores an associated list of material used or needed during the creation of the improvised pattern, and each material from the resulting list of material may be associated with an accompanying round/row/stitch location or other portions of the stitch data so that others can download the improvised patterns all associated lists of materials for their subsequent use.

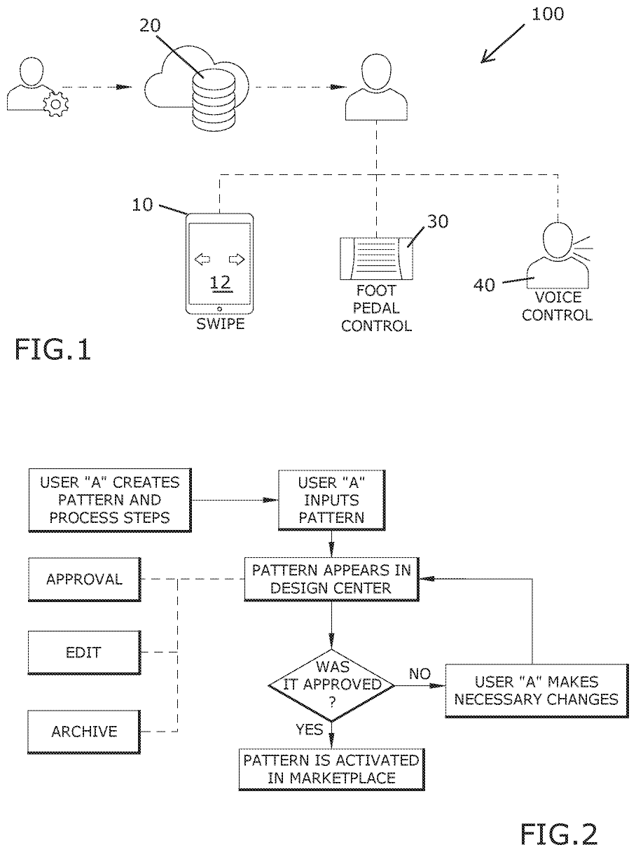

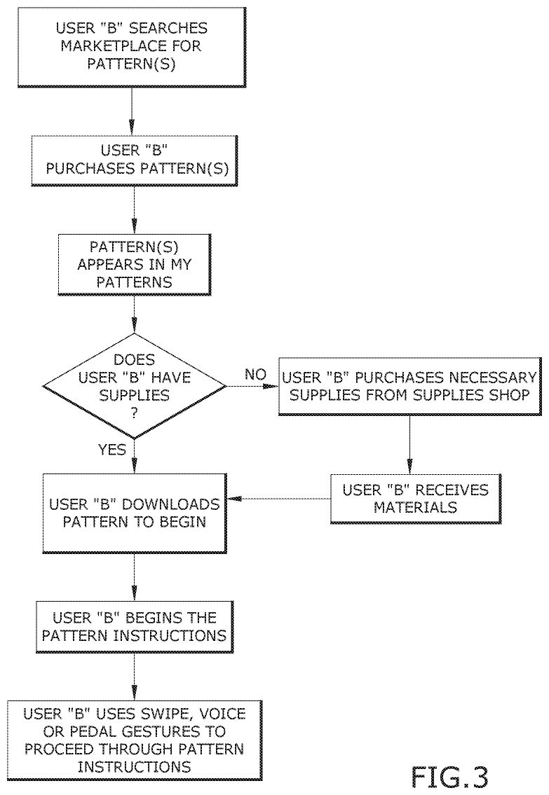

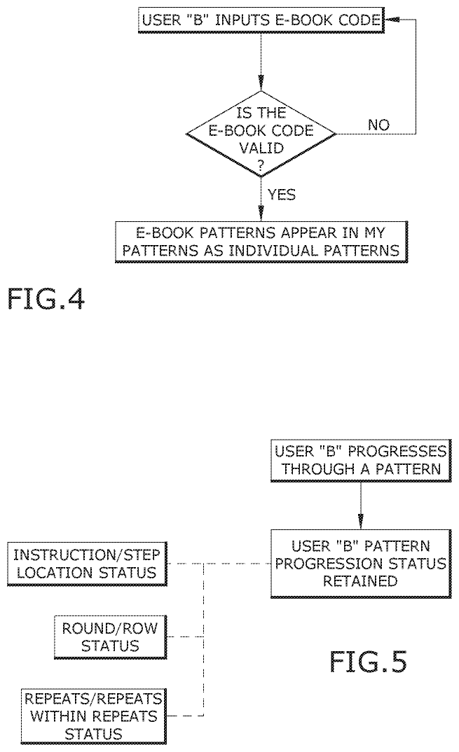

Referring now to FIGS. 1 through 5, the present invention may provide a yarn crafting system 100 including at least one computer 10 with a user interface 12 with touchscreen or other haptic functionality. The computer 10 may include at least one processing unit coupled to a form of memory. The computer 10 may include, but not limited to, a microprocessor, a server, a desktop, laptop, and smart device, such as, a tablet and smart phone. The computer 10 includes a program product including a machine-readable program code for causing, when executed, the computer 10 to perform steps. The program product may include software which may either be loaded onto the computer 10 or accessed by the computer 10. The loaded software may include an application on a smart device. The software may be accessed by the computer 10 using a web browser. The computer 10 may access the software via the web browser using the internet, extranet, intranet, host server, internet cloud and the like.

The yarn crafting system 100 may operatively associate the computer 10, a database 20, a foot pedal control device 30, a virtual design center, and a voice control functionality 40.

The virtual design center may include an online user portal, an online marketplace and online supply shop providing a plurality of electrically stored yarn craft patterns. The design center is where a designer, through a series of steps, inputs and builds their pattern to be sold within the marketplace. The marketplace may be where all patterns are sold. Once a pattern is purchased, materials (supplies) that are suggested on an associated material list are linked to the supplies store and the relevant pattern. The supplies store may be a location to purchase supplies not linked on a material list. The user portal may be a location where the patterns that are purchased and now owned by the user are located and can be accessed online or downloaded for offline use (e.g., for the demonstrating of a pattern).

The design center may provide pattern demonstration functionality for creating a predetermined item or article from the pattern using a series of steps, including a swipe motion via the touchscreen 12 of the computer 10 and/or the manipulation of the foot pedal control device 30 to electronically navigate and store the stitching steps and the corresponding round/row/stitch location.

The voice control functionality 40 may include voice recognition so that a user can speak a set of predefined word commands to navigate the patterns in the same way the user would use the swipe motion or the foot pedals control device 30. The voice commands can be given through a built-in microphone on the computer 10 or other computer peripherals, such as a headset.

A user with experience in creating or designing patterns in the craft of crocheting, knitting, needlepoint and weaving inputs these patterns into the software using a series of steps to capture and store the data, in certain embodiments, via the design center. These patterns may be made available for purchase through the marketplace. When a pattern is purchased it becomes available to the person who purchased it and can be accessed anytime from their library of purchased patterns (i.e., via the user portal). While subsequently purchasing one or more patterns the user may also purchase the suggested items on the material list for that pattern by tapping a button. The purchased material list items are shipped to the user. The user may also at any time purchase any item and quantity from the supplies store and it will be shipped to the user. When the user accesses their pattern, they must download it to their computing device by selecting the download button. Once the pattern is downloaded the user may press the start button to start demonstrating the pattern. The user may use a swipe motion, foot pedal, or voice commands to navigate the pattern. As the user navigates through the pattern, the software stores the navigation location and accompanying round/row/stitch location.

In certain embodiments, the user may not be enabled to demonstrate a pattern without a pattern being offered for sale and without a pattern being purchased and downloaded to the device, nor can the pattern be demonstrated without the navigation swipe motion/ foot pedal or voice commands through the series of steps. A user does not need to purchase items on the material list or through the supplies store to demonstrate a pattern.

A method of using the present invention may include the following. The yarn crafting system 100 disclosed above may be provided. Through the computer 10 and the electronically coupled foot pedal control device 30, the user may retrievably store the series and sequence of stitch locations and associated stitch rounds and rows (e.g., “stitch data”) incorporated in a simultaneously created or improvised yarn craft pattern during the crafting process. The resulting stitch data provides a road map for subsequent users to navigate through the improvised pattern when they recreate it. The computer 10 tracks and stores an associated list of material used or needed during the creation of the improvised pattern, and each material from the resulting list of material may be associated with an accompanying round/row/stitch location or other portions of the stitch data. In certain embodiments, users may export such improvised patterns and associated list of materials (stitch data)—for example through the design center—so that others can download and store of patterns and all associated lists of materials for their subsequent use. Such use may have to be purchased. The user interface 12 may also represent a demonstration of the pattern using the stitch data by way of the electronic road map/navigation associated with the improvised pattern. All the hereabove mentioned may be software enabled.

The present invention may embody an e-book wherein a user can input a 16-digit numerical code and instantly download all patterns from that e-book as separate patterns. For example, an afghan book may have twenty afghan patterns. When the user inputs the code to redeem that particular book, the user will instantly have those twenty afghan patterns as individual patterns in their user portal section.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A yarn crafting system, comprising:
a computer; and
a foot pedal control device electrically coupled to the computer, wherein a series of stitches in a yarn crafting process involving a plurality of crafting articles is tracked and retrievable stored through manipulation of the foot pedal control device.

2. The yarn crafting system of claim 1, wherein the computer is configured to retrievably store a list of materials comprising the plurality of crafting articles.

3. The yarn crafting system of claim 2, wherein the computer is configured to retrievably store a stich round, stitch row, and a stitch location associated with the series of stitches.

4. The yarn crafting system of claim 3, wherein the computer is configured to retrievably associate each crafting article of the plurality of crafting articles with at least one of the stich round, stitch row, and a stitch location.

5. The yarn crafting system of claim 4, wherein the series of stitches consists of a crafting pattern.

6. The yarn crafting system of claim 2, wherein the plurality of crafting articles comprises the type and color of yarn or equivalent filament.

7. The yarn crafting system of claim 1, wherein the yarn crafting process comprises crocheting, knitting, needlepoint and weaving.

8. The yarn crafting system of claim 5, further comprising a design center for exporting the crafting pattern and associated list of materials for subsequent download by remote users.

9. The yarn crafting system of claim 5, further comprising a voice control functionality coupled to the computer, wherein the voice control functionality is configured to be activated by a set of predefined word commands for navigating the crafting pattern.
